(19) United States
(12) Patent Application Publication
(10) Pub. No.: US 2010/0007951 A1
(43) Pub. Date: Jan. 14, 2010

(54) STEREOGRAM METHOD AND APPARATUS

(76) Inventors: Deborah J. Bramstedt, Marine on St. Croix,, MN (US); Robert A. Bramstedt, Marine on St. Croix, MN (US)

Correspondence Address: SCHWEGMAN, LUNDBERG & WOESSNER, P.A., P.O. BOX 2938, MINNEAPOLIS, MN, 55402, US

(21) Appl. No.: 12/502,174

(22) Filed: Jul. 13, 2009

Related U.S. Application Data
(60) Provisional application No. 61/080,100, filed on Jul. 11, 2008.

(51) Int. Cl. G02B 27/22

(52) U.S. Cl. 359/462

(57) ABSTRACT

An apparatus may include a meditative stereogram adapted or selected to encourage meditation of a subject and an audio track paired with the stereogram to work in cooperation with the stereogram to encourage the subject to reach a meditative state.

### RELATED APPLICATIONS

This application claims the benefit of U.S. Provisional Application No. 61/080,100, filed Jul. 11, 2008, the disclosure of which is incorporated herein by reference.

### TECHNICAL FIELD

The invention relates generally to the field of three dimensional images, and more particularly to images that create the illusion of three dimensions.

### SUMMARY OF THE INVENTION

According to one example embodiment, there is provided a meditative stereogram adapted to encourage meditation of a subject, wherein the stereogram is adapted to work in cooperation with an audio track paired with the stereogram to encourage the subject to reach a meditative state.

### Terminology

As used herein, the term “stereogram” is used interchangeably with autostereogram or random dot autostereogram or picture. The term “Random Dot Stereogram”, or RDS, is used interchangeably with random dot autostereogram. Single Image Stereogram (SIS) is used herein as a synonym of autostereogram. A “wallpaper autostereogram” is a 2D image where patterns are repeated at various intervals to raise or lower each pattern's perceived 3D location in relation to a virtual background plane. A random-dot autostereogram is also referred to as a Single Image Random Dot Stereogram (SIRDS). This term also refers to autostereograms where intelligible patterns instead of random dots are used. A Single Image Random Text Stereogram, or SIRTS, is an alternative to SIRDS using random normally ASCII text instead of dots to produce a 3D form of ASCII art.

### BRIEF DESCRIPTION OF THE DRAWING

FIG. 1 illustrates a system including a meditative stereogram according to the inventive subject matter disclosed herein.

FIG. 2 illustrates an example embodiment of an audio track according to the inventive subject matter disclosed herein.

FIGS. 3A and 3B illustrate a flow chart of methods of selecting meditative stereograms or audio tracks according to the inventive subject matter disclosed herein.

FIG. 4 illustrates a kit according to one example embodiment of the inventive subject matter disclosed herein.

FIG. 5 illustrates a networked system according to one example embodiment of the inventive subject matter disclosed herein.

### DETAILED DESCRIPTION

A single-image stereogram (SIS) or stereogram, is designed to create the visual illusion of a three-dimensional (3D) scene from a two-dimensional image in the human brain. In order to perceive 3D shapes in these stereograms, the brain must overcome the normally automatic coordination between focusing and vergence.

The simplest type of stereogram consists of horizontally repeating patterns and is known as a wallpaper stereogram. When viewed with proper vergence, the repeating patterns appear to float above or below the background. Another type of stereogram is called a random dot stereogram. In this type of stereogram, every pixel in the image is computed from a pattern strip and a depth map. Usually, a hidden 3D scene emerges when the image is viewed with the correct vergence.

There are two ways a stereogram can be viewed: wall-eyed and cross-eyed. Most stereograms (including those in this article) are designed to be viewed in only one way, which is usually wall-eyed. Wall-eyed viewing requires that the two eyes adopt a relatively parallel angle, while cross-eyed viewing requires a relatively convergent angle.

When the brain is presented with a repeating pattern like wallpaper, it has difficulty matching the two eyes' views accurately. By looking at a horizontally repeating pattern, but converging the two eyes at a point behind the pattern, it is possible to trick the brain into matching one element of the pattern, as seen by the left eye, with another (similar looking) element, beside the first, as seen by the right eye. With the typical wall-eyed viewing, this gives the illusion of a plane bearing the same pattern but located behind the real wall. The distance at which this plane lies behind the wall depends only on the spacing between identical elements. See Andrew A. Kinsman (1992). Random Dot Stereograms. Rochester: Kinsman Physics.

The brain is capable of almost instantly matching hundreds of patterns repeated at different intervals in order to recreate correct depth information for each pattern. A stereogram may contain many icons of varying size, repeated at different intervals against a complex, repeated background. Yet, despite the apparent chaotic arrangement of patterns, the brain is able to place every icon at its proper depth.

When a series of stereograms are shown one after another, in the same way moving pictures are shown, the brain perceives an animated stereogram. If all stereograms in the animation are produced using the same background pattern, it is often possible to see faint outlines of parts of the moving 3D object in the 2D stereogram image without wall-eyed viewing; the constantly shifting pixels of the moving object can be clearly distinguished from the static background plane. To eliminate this side effect, animated stereograms often use shifting background in order to disguise the moving parts.

### Depth Maps

The distance relationship between any pixel and its counterpart in the equivalent pattern to the left can be expressed in a depth map. A depth map is simply a grayscale image which represents the distance between a pixel and its left counterpart using a grayscale value between black and white. By convention, the closer the distance is, the brighter the color becomes. Using this convention, a grayscale depth map for the above stereogram can be created with black, gray and white representing shifts of 0 pixels, 10 pixels and 20 pixels, respectively. A software program can combine a depth map with an accompanying pattern image and produce a stereogram.

### Vision

The eye operates like a photographic camera. It has an adjustable iris which can open (or close) to allow more (or less) light to enter the eye. As with any camera except pinhole cameras, it needs to focus light rays entering through the iris (aperture in a camera) so that they focus on a single point on the retina in order to produce a sharp image. The eye achieves this goal by adjusting a lens behind the cornea to refract light appropriately. When a person stares at an object, the two eyeballs rotate sideways to point to the object, so that the object appears at the center of the image formed on each eye's retina. In order to look at a nearby object, the two eyeballs rotate towards each other so that their eyesight can converge on the object. This is referred to as cross-eyed viewing. To see a faraway object, the two eyeballs diverge to become almost parallel to each other. This is known as wall-eyed viewing, where the convergence angle is much smaller than that in a cross-eyed viewing. Stereo-vision based on parallax allows the brain to calculate depths of objects relative to the point of convergence. It is the convergence angle that gives the brain the absolute reference depth value for the point of convergence from which absolute depths of all other objects can be inferred.

Decoupling focus from convergence tricks the brain into seeing 3D images in a 2D stereogram. The eyes normally focus and converge at the same distance in a process known as accommodative convergence. That is, when looking at a faraway object, the brain automatically flattens the lenses and rotates the two eyeballs for wall-eyed viewing. It is possible to train the brain to decouple these two operations. This decoupling has no useful purpose in everyday life, because it prevents the brain from interpreting objects in a coherent manner. To see a man-made picture such as a stereogram where patterns are repeated horizontally, however, decoupling of focusing from convergence is crucial.

As with a photographic camera, it is easier to make the eye focus on an object when there is intense ambient light. With intense lighting, the eye can constrict the iris, yet allow enough light to reach the retina. The more the eye resembles a pinhole camera, the less it depends on focusing through the lens. In other words, the degree of decoupling between focusing and convergence needed to visualize a stereogram is reduced. This places less strain on the brain. Therefore, it may be easier for first-time stereogram viewers to “see” their first 3D images if they attempt this feat with bright lighting.

Vergence control is important in being able to see 3D images. Thus it may help to concentrate on converging/diverging the two eyes to shift images that reach the two eyes, instead of trying to see a clear, focused image. Although the lens adjusts reflexively in order to produce clear, focused images, voluntary control over this process is possible. The viewer alternates instead between converging and diverging the two eyes, in the process seeing “double images” typically seen when one is drunk or otherwise intoxicated. Eventually the brain will successfully match a pair of patterns reported by the two eyes and lock onto this particular degree of convergence. The brain will also adjust eye lenses to get a clear image of the matched pair. Once this is done, the images around the matched patterns quickly become clear as the brain matches additional patterns using roughly the same degree of convergence.

### Stereogram Viewing

The majority of stereograms are designed for divergent (wall-eyed) viewing. One way to help the brain concentrate on divergence instead of focusing is to view the picture in front of the face, with the nose touching the picture. With the picture so close to their eyes, most people cannot focus on the picture. The brain may give up trying to move eye muscles in order to get a clear picture. If one slowly draws back from the picture, while refraining from focusing or rotating eyes, at some point the brain will lock onto a pair of patterns when the distance between them match the current convergence degree of the two eyeballs.

Another way is to stare at an object behind the picture in an attempt to establish proper divergence, while keeping part of the eyesight fixed on the picture to convince the brain to focus on the picture. A modified method has the viewer stare at her reflection on the shiny surface of the picture, which the brain perceives as being located twice as far away as the picture itself. This may help persuade the brain to adopt the required divergence while focusing on the nearby picture.

For crossed-eyed stereograms, a different approach needs to be taken. The viewer may hold one finger between his eyes and move it slowly towards the picture, maintaining his focus on the finger at all times, until he is correctly focused on the spot between him and the picture that will allow him to view the illusion.

### Meditation

Meditation is a discipline in which one attempts to get beyond the conditioned, “thinking” mind into a deeper state of relaxation or awareness. It often involves turning attention to a single point of reference. Meditation is recognized as a component of almost all religions, and has been practiced for over 5,000 years. It is also practiced outside religious traditions. Different meditative disciplines encompass a wide range of spiritual and/or psychophysical practices which can emphasize different goals—from the achievement of a higher state of consciousness, to greater focus, creativity or self-awareness, or just simply a more relaxed and peaceful frame of mind.

Meditation has been defined as: “self regulation of attention, in the service of self-inquiry, in the here and now.” See Maison, A.; Herbert, J. R.; Werheimer, M.d.; & Kabat-Zinn, J. (1995) Meditation, melatonin and breast/prostate cancer: hypothesis and preliminary data, Medical Hypotheses 44 (1): 39-46. The various techniques of meditation can be classified according to their focus. Some focus on the field or background perception and experience, also called “mindfulness”; others focus on a preselected specific object, and are called “concentrative” meditation. There are also techniques that shift between the field and the object. See Perez-De-Albeniz, Alberto; Jeremy Holmes (March 2000), Meditation: concepts, effects and uses in therapy, International Journal of Psychotherapy 5 (1): 49-59.

In mindfulness meditation, the meditator sits comfortably and silently, centering attention by focusing awareness on an object or process (either the breath, a sound: a mantra, moan or riddle evoking questions; a visualization, or an exercise). The meditator is usually encouraged to maintain an open focus: No thought, image or sensation is considered an intrusion. The meditator, with a ‘no effort’ attitude, is asked to remain in the here and now. Using the focus as an ‘anchor’ . . . “brings the subject constantly back to the present, avoiding cognitive analysis or fantasy regarding the contents of awareness, and increasing tolerance and relaxation of secondary thought processes.” Perez-De-Albeniz, Alberto; Jeremy Holmes (March 2000)Meditation: concepts, effects and uses in therapy, International Journal of Psychotherapy 5 (1): 49-59.

Meditation is attained through practiced control of the brain waves. Brain waves are electrical impulses, active 24 hours a day, and can be measured with an electroencephalogram (EEG). An EEG measures the frequency of these electrical impulses or currents in Hertz (HZ). There are four categories of brain wave patterns measurable with an EEG: Beta, Alpha, Theta and Delta. Beta (12-38 HZ) is one's normal, wide-awake state. Alpha (8-12 HZ) is awake, but relaxed, and is where the meditative process begins. Theta (3-8 HZ) is the state of light sleep or deep, meditative relaxation. Delta (0.2-3 HZ) is a dreamless and completely unconscious state of being. As one relaxes through meditation, brain waves actually begin to slow down from the normal waking consciousness of Beta to the slower brain wave activity of Alpha. Alpha waves are associated with accelerated learning, relaxed focus and enhanced creativity. As found through meditation, when you focus on something, there is a predominance of Alpha waves. “In preliminary experiments, researchers studied the brain waves of people while they were looking at [stereogram] images. After the subjects saw the hidden images, the EEG recorded more alpha waves, which is a type of brain activity that occurs in relaxed states like meditation.” Magic Eye Inc. and Marc Grossman, O. D., L. Ac. (2004) Magic Eye: Beyond 3D: Improve Your Vision, pg. 28. Through the continued practice of meditation, one may reach even the slower brain wave patterns of Theta or even Delta.

### Embodiments

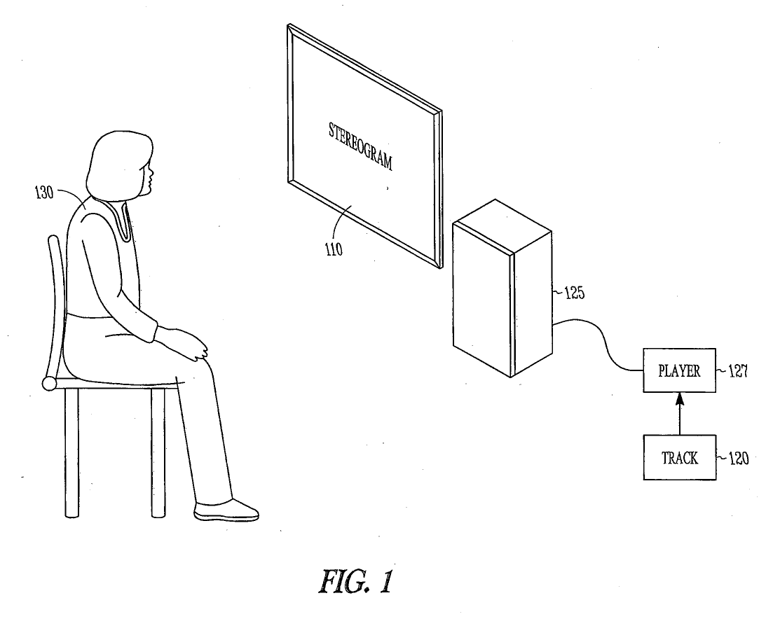

According to one example embodiment of the inventive subject matter, as illustrated in FIG. 1A, there is provided a meditative stereogram 110 and audio track 120 including music, sounds or voice instructions adapted to be used for meditation by a meditating subject 130. Audio track 120 is played to the meditating subject 130 using a music player 127 over a loud speaker 125. For example audio track 120 may be on a CD, a tape or in the form of a digital music file for example an MP3 file or an Apple iTunes format. Further, the stereogram may be a printed poster or a video display, still or video images. The stereogram 110 is selected and/or designed to provide a visual and thought focus for the meditating subject 130. The audio track 120 is selected and/or designed to provide an audio and thought focus for the meditating subject 130.

According to one example embodiment, the audio track 120 is a combination of a music track and voice track, playing simultaneously or one at a time.

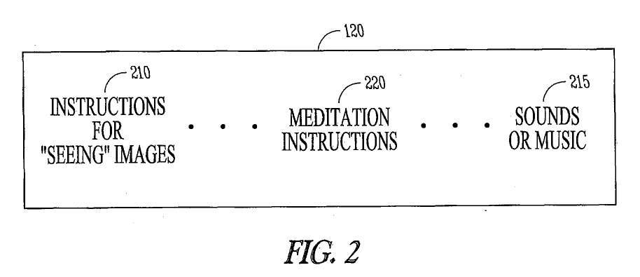

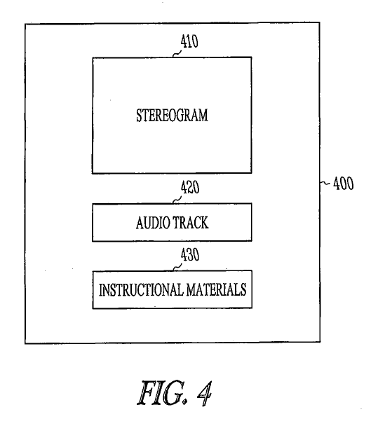

In one embodiment illustrated in FIG. 2A, the voice track optionally includes instructions 210 to direct the subject's attention on how to “see” the 3D effects of the stereogram 110 and subsequently call the viewer's attention to features or images in the stereogram. Alternatively, or additionally, the instructions on how to see the 3D effect are included in printed instructional materials illustrated in FIG. 4. The voice track may also instruct 220 the viewer on how to relax and reach a relaxed, meditative state, and include music or sounds 215 to get the viewer into or keep the viewer in a meditative state. The music track may be selected to provide a calming sound calculated to draw the subject into a relaxed, meditative state.

According to one example embodiment 3A, meditative stereograms are selected or designed to encourage the entry into and/or maintenance of a meditative state by a subject. Such selection or design may be achieved by, for example, experimentation 300, such that a stereogram under test may be evaluated 310 for its effectiveness to help produce a meditative state. Stereograms that are most effective for this purpose may be selected 320. According to another embodiment, stereograms characteristics that tend to be most effective to achieve or maintain meditative state are identified, and such characteristics are used to design new stereograms, either as modifications to known effective stereograms or as brand new stereograms.

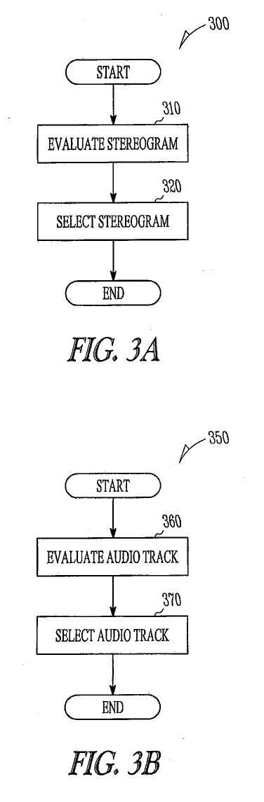

According to one example embodiment illustrated in FIG. 3B, meditative audio tracks are selected or designed to encourage the entry into and/or maintenance of a meditative state by a subject in conjunction with a particular meditative stereogram. Such selection or design may be achieved by, for example, experimentation 350, such that an audio track under test may be evaluated 360 for its effectiveness to produce a meditative state. Audio tracks that are most effective for this purpose may be selected 370. According to another embodiment, audio tracks characteristics that tend to be most effective to achieve or maintain meditative state are identified, and such characteristics are used to design new audio tracks, either as modifications to known effective audio tracks or as brand new audio tracks. According to another example embodiment, stereograms may be chosen to pair with audio tracks after the audio track has been chosen.

According to one example embodiment of the inventive subject matter, the meditating subject 130 is focusing on pregnancy and the meditative stereogram includes images such as a baby's room with crib, a teddy bear, a woman holding a baby in a rocking chair, for example, and the audio track includes soft baby chimes and lullaby selections intermixed with serene music and a soft female voice speaking with relaxing visualization and positive affirmations of perfect childbirth, for example.

According to another example embodiment of the inventive subject matter, the meditating subject 130 is an executive where the meditative stereogram includes images such as an outdoor scene with large rocks, pine trees, lake, birds, deer, for example, and the audio track includes loons, water rippling on the shore, rustling leaves with a male or female voice of guided relaxing imagery, for example.

According to still another example embodiment of the inventive subject matter, the meditating subject 130 is focusing on sports where the meditative stereogram includes images such as a baseball player hitting a home run at a ballpark, a race car driver leading the race and taking the checkered flag, a basketball player shooting hoops, or an archer hitting the bull's-eye, for example, and the audio track includes relaxing music with a male or female voice of visualization and winning affirmations, for example.

According to one more example embodiment of the inventive subject matter, the meditating subject 130 is focusing on his or her religion, in this case Christianity, where the meditative stereogram includes images such as Jesus' face, for example, and the audio track includes soft, spiritual music, intermixed with Gregorian chants and bells with a voice speaking of love, faith, hope, forgiveness, being a child of God, for example.

According to yet another example embodiment of the inventive subject matter, the meditating subject 130 is focusing on his or her health where the meditative stereogram includes images such as a sunlit meadow, butterflies, for example, and the audio track includes soft, serene music, spots of light-hearted music and bells with a voice speaking of relaxation, perfect health, positive-present affirmations of a healthy body, for example.

In still other embodiments of the inventive subject matter the meditating subject 130 focuses on one or more of the following: education/school; military personnel home and abroad; religions such as Judaism and Buddhism; addictions such as weight loss, smoking; women's relaxation, men's relaxation, personal affirmations, personal manifestations, positive health affirmations, positive financial affirmations; love/relationship; and spiritual enhancement, for example.

Referring now to FIG. 4, there is illustrated a kit 400 including a meditative stereogram 410, an audio track 420 and instructional materials 430, wherein materials 430 may include information on how to use the stereogram and audio track.

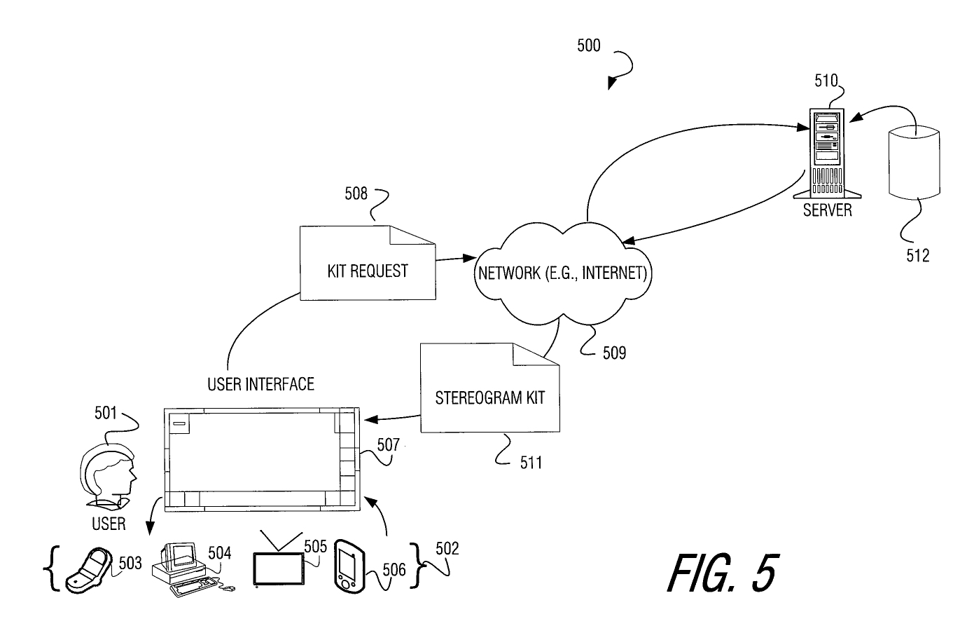

Referring now to FIG. 5, there is illustrated an example system 500 of the inventive subject matter including user 501, user device 502, user interface 507, a request for a kit 508, network 509, stereogram kit 511, server 510, and database 512. According to an example embodiment, user 501 uses user interface 507 which may reside on user device 502. As illustrated, user device 502 may include a mobile phone 503, personal computer 504, television 505, and personal media player 506. The interface may be an internet browser or other stand alone application capable of communicating over network 509. In an embodiment, network 509 is the Internet. User device 502 is communicatively coupled to server 510. The communication between user device 502 and server 510 may be wired (e.g., Ethernet) or wireless (e.g., 802.11b/n/g). Database 512 may store one or more autostereograms.

In an example embodiment of the inventive subject matter, user 501 subscribes to a service providing periodic (e.g., monthly) updated autostereogram kits. The service may be provided by a social networking website in exchange for a monthly fee. The updated autostereogram kit may be stored on user device 502. The autostereogram kit may include audio clips that are heard online (e.g., user interface 507) or downloaded to a different user device 502. In an example embodiment, the autostereogram kit is an animated autostereogram.

In yet another example embodiment of the inventive subject matter, user 501 submits a singular kit request 508 to server 510. Server 510 responds to request 508 by accessing database 512 and formatting a stereogram kit 511 which is transmitted through network 509 to user device 502. In an embodiment, server 510 is a social networking site. The transmission of stereogram kit 511 may including streaming the stereogram kit using one or more data encoding codecs. For example, video may be encoded as H.264 and the audio may be encoded as MP3. The kit may be displayed on a display device of user device 502.

According to one more example embodiment of the inventive subject matter a stereogram kit includes subject matter specific material. For example, spiritual, financial, relationships, family, health, addictions, religion, and career/work material. It may also include material specific to certain age and gender groups. In an embodiment, a kit includes an autostereogram image and one or more of the following: prepared audio clips (e.g., music, nature, affirmations) and/or client personalized and recorded sound bites. In an example embodiment, the autostereogram kit is packaged with instructions on a storage medium such as a DVD, CD-ROM, or flash memory device. In the case of a playable medium (e.g., DVD) instructions may be printed on the packaging.

Accordingly, there has been described above a method, system, articles of manufacture and a kit for using meditative stereograms. According to certain example embodiments, the stereograms and audio tracks are specially matched to one another, although such special matching is not strictly required by other embodiments.

What is claimed is:

1. Apparatus comprising:
a meditative stereogram adapted or selected to encourage meditation of a subject; and
an audio track paired with the stereogram to work in cooperation with the stereogram to encourage the subject to reach a meditative state.

2. A kit comprising:
a meditative stereogram adapted or selected to encourage meditation of a subject; an audio track paired with the stereogram to work in cooperation with the stereogram to encourage the subject to reach a meditative state; and
instructions to inform the subject on how to use at least one of the stereogram and audio track to reach a meditative state.
